(19) United States
(12) Patent Application Publication
(10) Pub. No.: US 2006/0129820 A1
(43) Pub. Date: Jun. 15, 2006

(54) Object oriented program communication system with an object for sending a certification of the existence of events justifying response actions

(75) Inventors: Michael Pierre Carlson, Austin, TX (US); Linda Arnold Lisle, Cedar Park, TX (US); Herman Rodriguez, Austin, TX (US)

Correspondence Address: IBM CORPORATION;INTELLECTUAL PROPERTY LAW, 11400 BURNET ROAD, AUSTIN, TX, 78758, US

(73) Assignee: International Business Machines Corporation, Armonk, NY (US)

(21) Appl. No.: 11/008,809

(22) Filed: Dec. 9, 2004

(51) Int. Cl. H04L 9/00

(52) U.S. Cl. 713/175

(57) ABSTRACT

A new communicating object class is created: “The electronic excuse object”. This is an object class that provides for the automatic distribution via a communications network of a certification by an accepted authority of the existence of events justifying a responsive action or inaction by an entity, e.g. a person subjected to the effects of such events. A system for the certification of the existence of events enabling responsive actions that comprise at least one object of an object class including the identity of the entity authorized to make the certification, the identity of the entity enabled to take the responsive actions and a certification by the authorized entity of the existence of the events and a communication network process through which this object may be accessed so as to provide the certification to a designated recipient. The object contains an appropriate programming process for sending an electronic communication, such as an e-mail or Web document, to the designated recipients.

### TECHNICAL FIELD

The present invention relates to user-interactive object oriented programming systems, and particularly to such object oriented systems that function in a networking environment, such as the World Wide Web (Web) or equivalent proprietary or public network to perform functions defined in program objects.

### BACKGROUND OF RELATED ART

The past decade has been marked by a technological revolution driven by the convergence of the data processing industry with the consumer electronics industry. The effect has, in turn, driven technologies that had been known and available but relatively quiescent over the years. Two of these technologies are the Internet, i.e. Web, related distribution and object oriented programming systems. Both of these technologies are embodied in the object oriented Java (“Java” is a trademark of Sun Microsystems, Inc.) programming system. The computer and communications industries have been extensively participating in the development and continual upgrading of the Java system. For details and background with respect to the Java system, reference may be made to a typical text, Just Java, 2nd Edition, Peter van der Linden, Sun Microsystems, 1997, or the text, Thinking in Java, Bruce Eckel, Prentice Hall, 1998.

The convergence of the electronic entertainment and consumer industries with data processing exponentially accelerated the demand for wide ranging communication distribution channels and the Web or Internet that had quietly existed for over a generation as a loose academic and government data distribution facility reached “critical mass” and commenced a period of phenomenal expansion that has not, as yet, abated.

Object oriented programming, which also had been virtually languishing for a generation, offered the ideal distribution vehicle for the Web. With its potentially interchangeable objects or units within which both data attributes and functions were stored in a predefined uniform framework, as well as the predefined object interfaces with each other, object oriented programming systems have found acceptance as the programming system for the Internet or Web. In all areas of data processing, communications, as well as the electronic entertainment and consumer industries, having anything to do with the Web, there has been a substantial movement to object oriented programming systems.

With the development and rapid expansion of the Web and other like networks, hypertext markup languages became the primary vehicle for distribution of data over such networks. A basic hypertext language, HTML, is described in detail in the above-entitled Just Java text, particularly at Chapter 7, pp. 249-268, dealing with the handling of Web pages; and also in the text, Mastering the Internet, G. H. Cady et al., published by Sybex Inc., Alameda, Calif., 1996, particularly at pp. 637-642, on HTML in the formation of Web pages. The Web pages are implemented so as to be used for the distribution of Web documents containing text and images.

In addition to the above evolving technologies: the Web distribution network; object oriented programming; and hypertext markup languages have recently been correlated into a system for distribution and exchange, via the Web, of data between any two remote computer applications. The system is specifically known as Web Services. The system is based on both suppliers of the data in the form of text based documents and the users of such data conforming to several industry standards developed by the World Wide Web Consortium (W3C). The primary standard is a HTML based language, Extensible Markup Language (XML), for defining data and creating markup languages in the form of XML tags.

Based upon the productive potential of the above-described distribution environment, the object oriented communication industries and its consumers are continually seeking communicatable program objects facilitating the distribution and performance of business, educational and governmental functions.

### SUMMARY OF THE PRESENT INVENTION

The present invention provides a program object for performing a novel time and work saving function. A new communicating object class is created: “The electronic excuse object”. This is an object class that provides for the automatic distribution via a communications network of a certification by an accepted authority of the existence of events justifying a responsive action or inaction by an entity, e.g. a person subjected to the effects of such events. The most common example would be the certification of an illness or hospital of incapacitation by an illness preventing work, school, government appearance, e.g. court, or travel commitment by an individual or like entity. Other possible situations would be a certification by an airline of a flight delay or cancellation preventing the appearance of an individual on the flight at a scheduled destination; or a certification of a court of law that an individual is being delayed from another scheduled appearance.

Thus, the present invention provides a computer controlled object oriented program communication system for the certification of the existence of events enabling responsive actions that comprise at least one object of an object class including the identity of the entity authorized to make said certification, the identity of the entity enabled to take said responsive actions and a certification by the authorizing entity of the existence of said events and a communication network process through which this object may be accessed so as to provide the certification to a designated recipient. The object contains an appropriate programming process for sending an electronic communication, such as an e-mail or Web document to the designated recipients. This communication process may be automatically carried out in response to the existence of the events enabling the certification. Provision may be made for limiting the time period of the certification.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of implementing the sending display stations at the certifying facility on which the program object may function. The data processing system may be used for all of the other computers used in Web servers and servers at Web service providers, as well as for receiving Web terminals at recipient terminals;

FIG. 2 is a generalized diagrammatic view of a Web portion upon which the present invention may be implemented;

FIG. 3 is a general flowchart of a program set up to implement the present invention for the creation and functioning of the certification programming objects; and

FIG. 4 is a flowchart of an illustrative run of the program set up in FIG. 3.

### DETAILED DESCRIPTION OF THE PREFERRED EMBODIMENT

Before going into the details of specific embodiments, it will be helpful to understand from a more general perspective the various elements and methods that may be used to implement the present invention. The present invention may be implemented using the Java Programming system, which is an object oriented system utilizing the Java programming language. The Java system and language are extensively familiar to those skilled in the art. The above-referenced texts, Thinking in Java and Just Java, comprehensively detail the system and language. Nonetheless, it should be helpful to generally review the known principles of object oriented programming.

It should be understood by those skilled in the art that object oriented programming techniques involve the definition, creation, use and instruction of “objects”. These objects are software entities comprising data elements or attributes and methods that manipulate the data elements. Objects may also include data related to events outside of the object to trigger or control methods within the object. The data and related methods are treated by the software as an entity and can be created, used and deleted as such. The data and functions enable objects to model their real world equivalent entity in terms of its attributes, which can be represented by the data elements, and its behavior, which can be represented by its methods.

Objects are defined by creating “classes” that are not objects themselves, but act as templates that instruct a compiler on how to construct the actual object. For example, a class may specify the number and type of data variables and the steps involved in the functions that manipulate the data. An object is actually created in the program by means of a special function called a constructor that uses the corresponding class definition and additional information, such as arguments provided during object creation, to construct the object. Objects are destroyed by a special function called a destructor.

Many benefits arise out of three basic properties of object oriented programming techniques, encapsulation, polymorphism and inheritance. Objects can be designed to hide or encapsulate all or a portion of the internal data structure and the internal functions. More particularly, during program design, a program developer can define objects in which all or some of the data variables and all or some of the related methods are considered “private” or for use only by the object itself. Other data or methods can be declared “public” or available for use by other software programs. Access to the private variables and methods by other programs can be controlled by defining public methods that access the object's private data. The public methods form an interface between the private data and external programs. An attempt to write program code that directly accesses the private variables causes a compiler to generate an error during program compilation. This error stops the compilation process and prevents the program from being run.

Polymorphism allows objects and functions that have the same overall format, but work with different data to function differently to produce consistent results. For example, an object may have a format of attribute data and methods to support a geometric shape. The same format can be used whether the shape is a rectangle or a circle. However, the actual program code that performs the shape formation may differ widely depending on the type of variables that comprise the shape. After the methods have been defined, a program can later refer to the shape formation method by its common format and, during compilation, the compiler will determine which of the shaping methods to use by examining the variable types. The compiler will then substitute the proper function code.

A third property of object oriented programming is inheritance that allows program developers to reuse pre-existing programs. Inheritance allows a software developer to define classes and the objects that are later created from them as related through a class hierarchy. Specifically, classes may be designated as subclasses of other base classes. A subclass “inherits” and has access to all of the public functions of its base class as though these functions appeared in the subclass. Alternatively, a subclass can override some or all of its inherited functions or may modify some or all of its inherited functions by defining a new function with the same form.

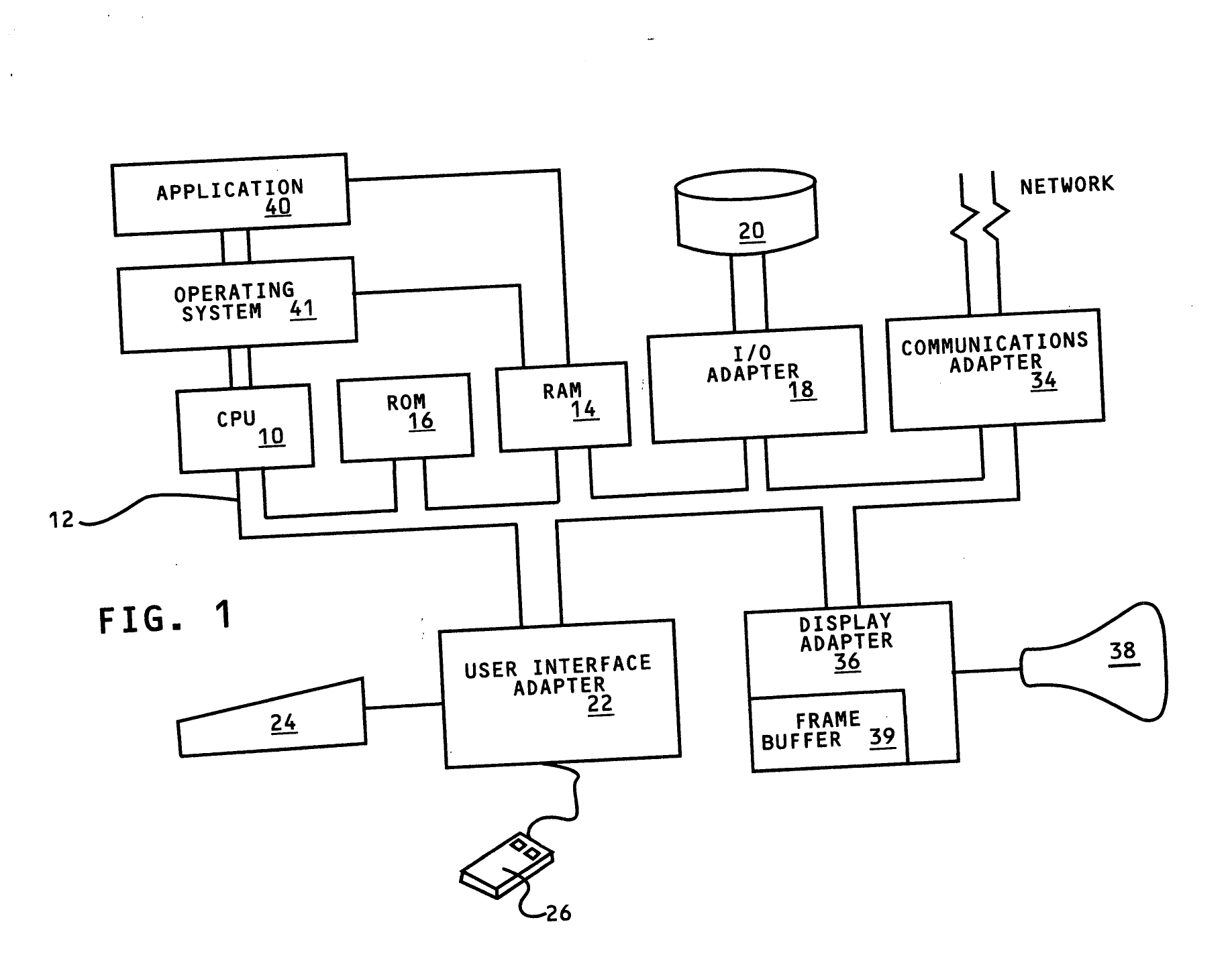

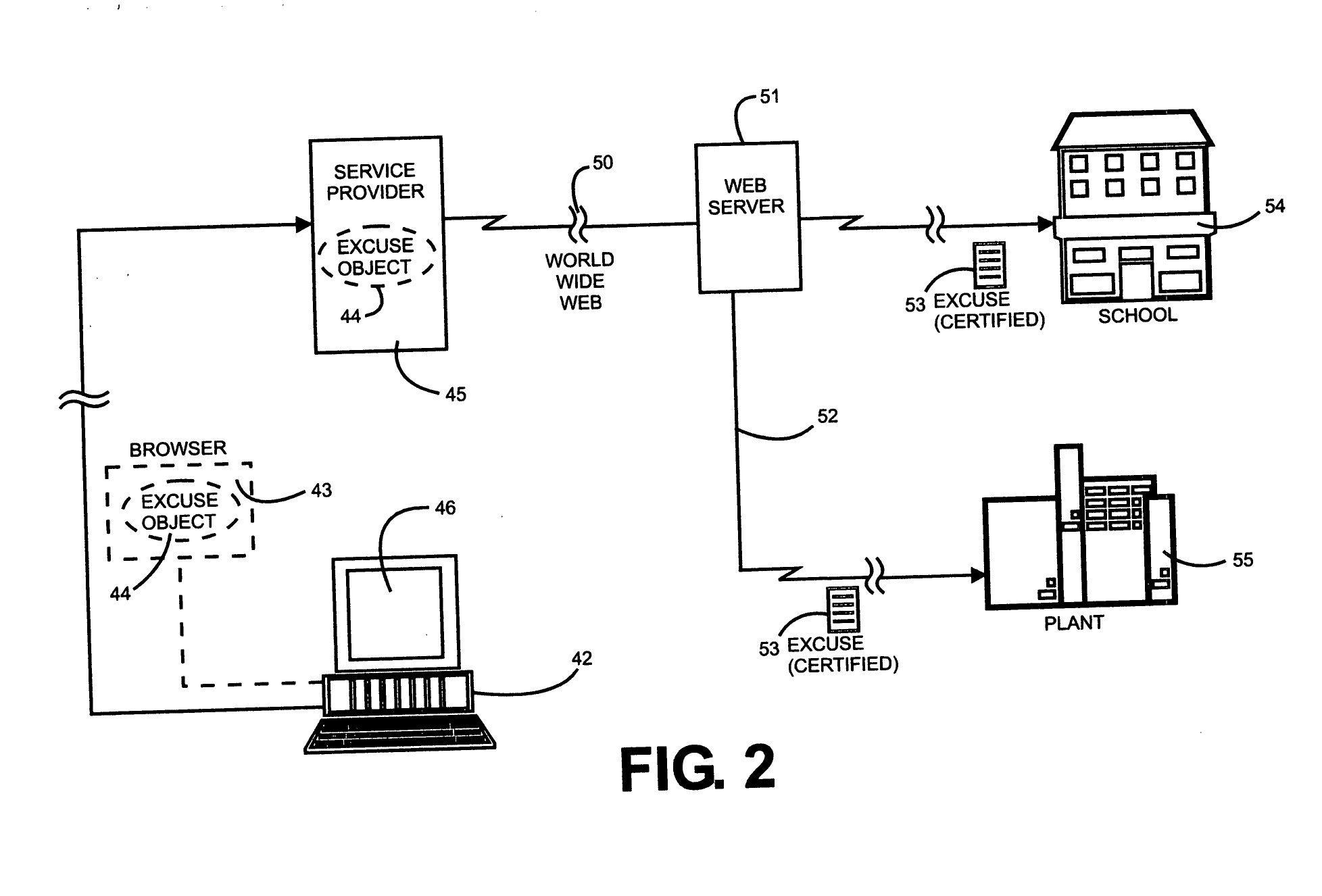

Referring to FIG. 1, a typical data processing system is shown that may be used in conjunction with object oriented software, such as Java, in implementing the present invention. As will be hereinafter described with respect to FIG. 2, this data processing system may function as the display terminal at a certifying facility upon which the certification object of the present invention may be set up. The data processing system shown may also be used as any of the Web servers that connect local client display terminals, such as the terminal at the certifying facility to the Web. As will be described with respect to FIG. 2, such servers may perform all or part of the creation of the certification object.

In FIG. 1, a central processing unit (CPU) 10, such as one of the PC microprocessors or workstations, e.g. RISC System/6000™ series available from International Business Machines Corporation (IBM), or Dell PC microprocessors, is provided and interconnected to various other components by system bus 12. An operating system 41 runs on CPU 10, provides control and is used to coordinate the function of the various components of FIG. 1. Operating system 41 may be one of the commercially available operating systems, such as IBM's AIX 6000™ operating system or Microsoft's WindowsXP™ or Windows2000™, as well as UNIX and other IBM AIX operating systems. Application programs 40, controlled by the system, are moved into and out of the main memory Random Access Memory (RAM) 14. These programs include all of the object oriented programming discussed above for the practice of the present invention that will also be described hereinafter for operations wherein the system of FIG. 1 functions as the server supporting the user client terminal in the creation of the certification objects of the present invention.

A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside Internet or Web network as appropriate. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs of this invention. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through keyboard 24 or mouse 26 and receiving output information from the system via display 38.

A generalized example of the practice of the present invention involving an excuse or certification object will be considered with respect to FIG. 2 that shows a generalized portion of the Web. First, it should be helpful to understand from a more general perspective the various elements and methods that may be related to the present invention. Since the present invention is directed to certification objects that may result in Web hypertext documents, including e-mail transmitted over networks, an understanding of the Internet or Web and its operating principles would be helpful. Reference has also been made to the applicability of the present invention to a global network, such as the Internet or Web. For details on Internet nodes, objects and links, reference is made to the above-mentioned text, Mastering the Internet.

The Internet or Web is a global network of a heterogeneous mix of computer technologies and operating systems. Higher level objects are linked to lower level objects in the hierarchy through a variety of network server computers. These network servers are the key to network distribution, such as the distribution of Web pages and related documentation. In this connection, the term “documents” is used to describe data packets or data entities transmitted over the Web or other networks and is intended to include Web pages with displayable text, graphics and other images, as well as computer programs. Web documents are conventionally implemented in HTML language, which is described in detail in the above-referenced text, Just Java, particularly at Chapter 7, pp. 249-268, dealing with the handling of Web pages; and also in the text, Mastering the Internet, particularly at pp. 637-642, on HTML in the formation of Web pages. In addition, aspects of this description will refer to Web browsers. A general and comprehensive description of browsers may be found in the above-mentioned Mastering the Internet text at pp. 291-313. More detailed browser descriptions may be found in the text, Internet: The Complete Reference, Millennium Edition, M. L. Young et al., Osborne/McGraw-Hill, Berkeley Calif., 1999, Chapter 19, pp. 419-454, on the Netscape Navigator; Chapter 20, pp. 455-494, on the Microsoft Internet Explorer; and Chapter 21, pp. 495-512, covering Lynx, Opera and other browsers.

In light of this background, reference is made to FIG. 2 showing a portion of the Web set up for the distribution of certification documents in accordance with the present invention. For purposes of the present embodiment, let display 46, computer station 42 serve as a typical display station at a facility, e.g. a medical facility through which a certifying authority may generate object oriented program objects 44, by means of a conventional browser program 43, to automatically send excuse documents, such as e-mail, via the Web 50. While the objects of this invention may be created within the browser as shown, in the case of a medical facility, the objects 44 may most conveniently be created on the servers of the service provider 45 to the medical facility. It is presently accepted that service providers support a variety of administrative functions for the medical facility, e.g. accounting or patient's records, often as a Web Service. It then follows that the creation of the program object or the operation of the object to send e-mail certifying the existence of the condition could be effectively offered as a business service to the medical facility.

For example in a medical facility such as a doctor's clinic or hospital, the entry forms filled out by patients could solicit the choice and information needed for such e-mail certification. Then, upon the occurrence of the triggering events, the excuse object 44 could set up and transmit over the Web the appropriate certified message or documents 53 through Web servers 51 to either a school 54 or a plant or office 55.

While we have used the example of a medical facility, it should be clear that the object class used in this invention could be used in many other situations requiring appropriate certification by an authority. For example, a certification by a court of law confirming the need to hold or delay people, e.g. jury because of court duties; a certification by airlines that specific passengers have been delayed; notification by a bank that a financial transaction has been lost or misdirected through no fault of the client; or in military or national crisis situations, appropriate certifying notification, could be sent on a need to know basis. It should be noted that a great many of the above situations would involve confidentiality or secrecy. It should be understood that the object oriented programming system of this invention could be encrypted using any encryption appropriate to program objects. Such encryption schemes are well know in the art and it is beyond the scope and purpose of this invention to further describe such encryption programs.

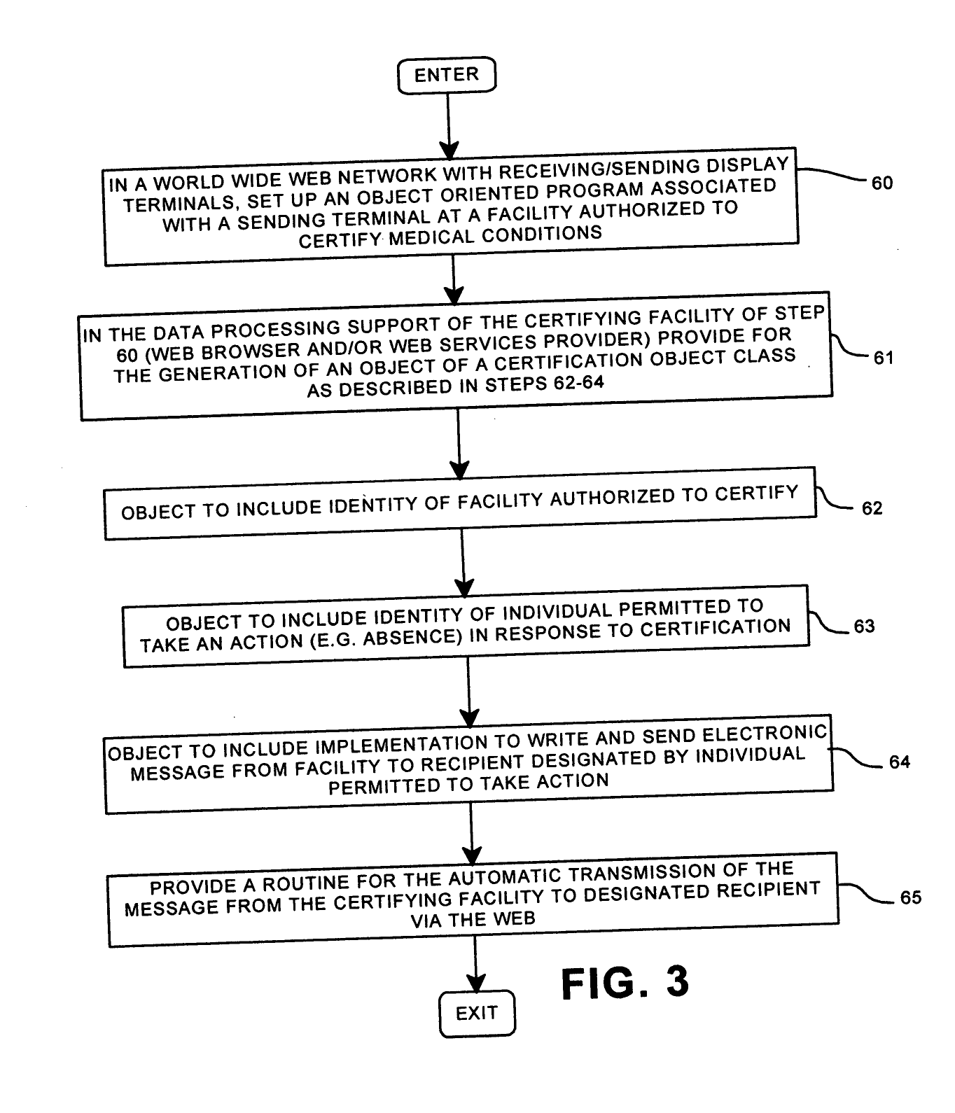

FIG. 3 is a flowchart showing the development of a process according to the present invention for creating certification objects, the resulting distribution certification messages are in a Web environment. Many of the programming functions in the process of FIG. 3 have already been described in general with respect to FIGS. 1 and 2. In a Web environment, the object oriented programs are,set up, for example at a medical facility, as described above, to certify medical conditions, step 60. In data processing support in association with the certifying facility of step 60, an object is generated, step 61, of a certification class to be described in steps 62 through 64. Accordingly, this object will include: the identity of the certifying authority, step 62; the identity of the individual, either person or institution, permitted to take an action or inaction in response to the certified triggering events, step 63; and the recipients designated to receive the certifying e-mail or like Web document, as well as a routine for generating this certifying document, step 64. Finally, there is a routine for automatically sending the certifying message upon the occurrence of the condition or events triggering such notification, step 65.

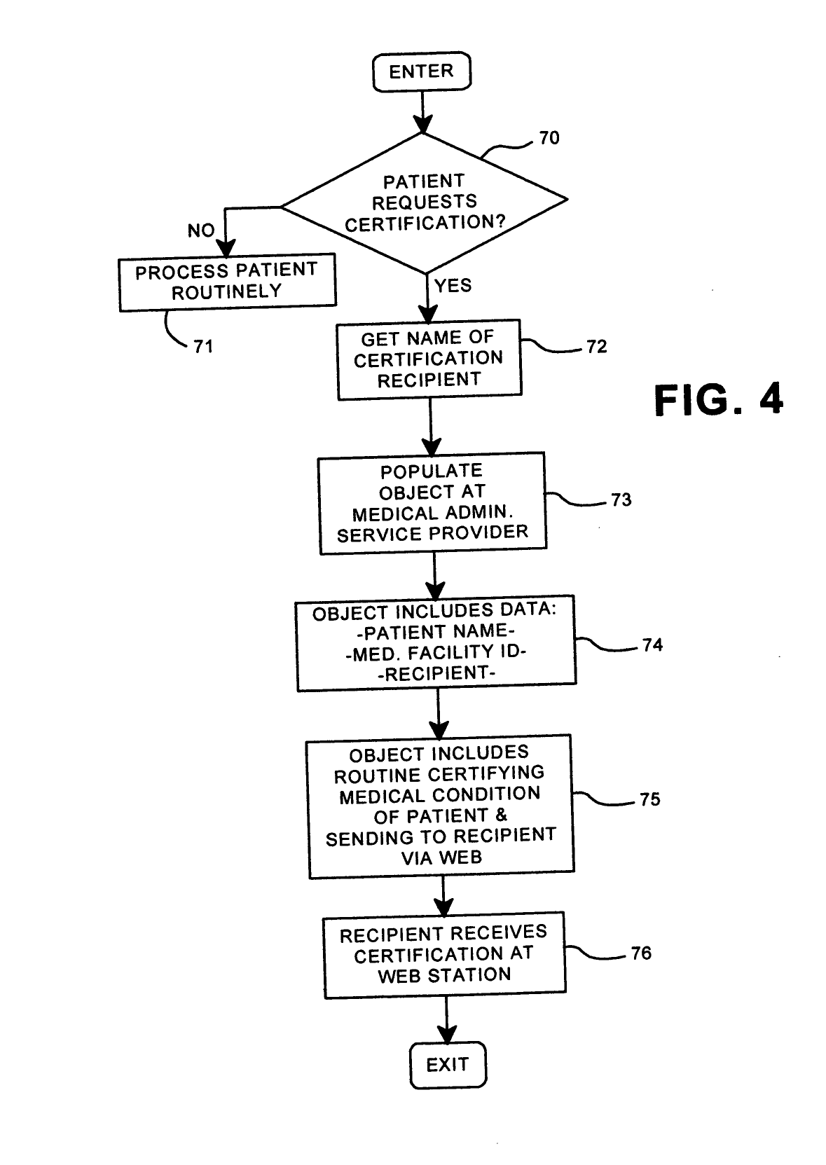

The running of the process set up in FIG. 3 will now be described with respect to the flowchart of FIG. 4. First, using the example of a medical facility, a determination is made as to whether the patient selects to have such certification, step 70. If No, the patient is routinely treated without such certification; but, if Yes, the name of the certification recipient is solicited and stored, step 72. An object of the certification class defined by the present invention is populated, preferably at the service provider server, step 73. The object created would include patient name, medical facility identification and the designated recipients of the certification, step 74. The object also includes a routine, step 75, for processing the data entered in step 74. This routine would include certifying the medical condition of the patient and sending an appropriate certification of this condition to the recipients via the Web, step 75. The designated recipients would receive the certifying document at their respective Web stations, step 76.

In one embodiment of the present invention, a designated recipient of the certifying document may be enabled to confirm the veracity of certain elements of the document. For instance, in the example of the medical facility, the recipient may want to confirm that the medical facility identification is authentic and not that of an imposter. The medical facility identification included in the certifying document may contain information that can be trusted and be relied upon by including certain credentials authentic only to that medical facility. For example, these credentials may be encrypted with the private key of the medical facility and may be authenticated by the recipient using the corresponding public key available from the medical facility. The credentials that authenticate the medial facility identification may further include or point to other information, such as the agency from which the medical facility received its accreditation.

Although certain preferred embodiments have been shown and described, it will be understood that many changes and modifications may be made therein without departing from the scope and intent of the appended claims.

What is claimed is:

1. A computer controlled object oriented program communication system for the certification of the existence of events enabling responsive actions comprising:
at least one object of an object class comprising:
identity of the entity authorized to make said certification;
identity of the entity enabled to take said responsive actions; and
a certification by said authorized entity of the existence of said events; and
communication network means for accessing said one object.

2. The object oriented program communication system of claim 1 wherein said means for accessing includes means for automatically sending said object to at least one recipient designated by said entity enabled to take said responsive action.

3. The object oriented program communication system of claim 2 wherein:
said authorized entity is a medical facility; and
said entity enabled to take said responsive action is a person treated by said medical facility.

4. The object oriented program communication system of claim 3 wherein:
said enabled responsive action is the absence of said treated person from an establishment; and
said certification is an excuse for said absence.

5. The object oriented program communication system of claim 4 wherein said establishment is a school.

6. The object oriented program communication system of claim 4 wherein said object further includes means for limiting the time of said certification.

7. The object oriented program communication system of claim 4 wherein said communication network is the World Wide Web.

8. A computer controlled object oriented programming communication method for the certification of the existence of events enabling responsive actions comprising:
generating an object of an object class comprising:
identifying the entity authorized to make said certification;
identifying the entity enabled to take said responsive actions; and
certifying the existence of said events by said authorized entity; and
accessing said object via a communication network.

9. The object oriented programming communication method of claim 8 wherein said accessing step includes automatically sending said object to at least one recipient designated by said entity enabled to take said responsive action.

10. The object oriented programming communication method of claim 9 wherein:
said authorized entity is a medical facility; and
said entity enabled to take said responsive action is a person treated by said medical facility.

11. The object oriented programming communication method of claim 10 wherein:
said enabled responsive action is the absence of said treated person from an establishment; and
said certification is an excuse for said absence.

12. The object oriented programming communication method of claim 11 wherein said establishment is a school.

13. The object oriented programming communication method of claim 11 wherein said object further includes limiting the time of said certification.

14. The object oriented programming communication method of claim 11 wherein said communication network is the World Wide Web.

15. In a computer controlled object oriented program communication system a computer program having program code included on a computer readable medium for the certification of the existence of events enabling responsive actions comprising:
at least one object of an object class comprising:
identity of the entity authorized to make said certification;
identity of the entity enabled to take said responsive actions; and
a certification by said authorized entity of the existence of said events; and
communication network means for accessing said one object.

16. The computer program of claim 15 wherein said means for accessing includes means for automatically sending said object to at least one recipient designated by said entity enabled to take said responsive action.

17. The computer program of claim 16 wherein:
said authorized entity is a medical facility; and
said entity enabled to take said responsive action is a person treated by said medical facility.

18. The computer program of claim 17 wherein:
said enabled responsive action is the absence of said treated person from an establishment; and
said certification is an excuse for said absence.

19. The computer program of claim 18 wherein said establishment is a school.

20. The computer program of claim 18 wherein said object further includes means for limiting the time of said certification.

21. The computer program of claim 18 wherein said communication network is the World Wide Web.
